(19) United States
(12) Patent Application Publication
(10) Pub. No.: US 2014/0283592 A1
(43) Pub. Date: Sep. 25, 2014

(54) METHOD FOR DETERMINING THE ACOUSTIC CHARACTERISTICS OF A MUD FILTER CAKE

(71) Applicant: SCHLUMBERGER TECHNOLOGY CORPORATION, SUGAR LAND, TX (US)

(72) Inventors: Timur Vyacheslavovich Zharnikov, Moscow (RU); Masafumi Fukuhara, Kanagawa (JP); Alexander Zazovsky, Houston, TX (US); Fernando Garcia-Osuna, Sugar Land, TX (US)

(21) Appl. No.: 14/348,370

(22) PCT Filed: Sep. 28, 2012
(86) PCT No.: PCT/RU2012/000792

§ 371 Date: Mar. 28, 2014

(30) Foreign Application Priority Data
Sep. 30, 2011 (RU) 2011139726

(51) Int. Cl. E21B 49/00; G01V 1/52

(52) U.S. Cl. CPC E21B 49/00; G01V 1/52
USPC 73/152.16

(57) ABSTRACT

A pressure response to low frequency harmonic pressure oscillations generated in a borehole by at least one oscillation source is registered by at least one acoustic sensor. A phase shift of stationary pressure oscillations registered by the acoustic sensor relatively to the low frequency harmonic pressure oscillations of the oscillation source and a ratio between an amplitude of the stationary pressure oscillations registered by the acoustic sensor and an amplitude of the low frequency harmonic pressure oscillations of the oscillation source are determined. A thickness of a mudcake is determined and based on the results a cake piezoconductivity or a fluid mobility or both are determined.

### CROSS-REFERENCE TO RELATED APPLICATIONS

This application is a U. S. National Stage Application under 35 U.S.C. §371 and claims priority to Patent Cooperation Treaty Application No. PCT/RU2012/000792 filed Sep. 28, 2012; which claims priority to Russian Application No. RU2011139726 filed Sep. 30, 2011. Both of these applications are incorporated herein by reference in their entireties.

### FIELD OF THE DISCLOSURE

The present invention relates to methods for acoustic characteristic determination of a mudcake created during well drilling, namely, fluid mobility and cake piezoconductivity.

### BACKGROUND OF THE DISCLOSURE

A mudcake is created during drilling with a drilling mud, fed into a borehole through a drilling string and removed through holes in a drill bit for lubrication of the drill bit during drilling and removal of drilled rocks to the surface. A layer of mudcake is formed as the fluid mixes with cuttings and/or other solids and circulates up through an annular space between an outer side of the drill string and the borehole wall. The mixture covers the borehole wall and forms a layer of mudcake. Isolation of a formation from an internal part of the borehole is one of the cake functions. The cake layer is frequently called as a mud cake or a filter cake.

Method of direct determination of mudcake properties during sampling while drilling is known. This method is described in WO 2009/139992. In this patent it is mentioned a possibility to use a low frequency acoustic sensor installed on a sampling probe in a listening mode to estimate pressure diffusivity (piezoconductivity) of a mudcake, K, that is directly associated with sealing properties of the mudcake. It is suggested to use a piston of a pretest chamber or any other device to create harmonic or periodic pressure oscillations.

### SUMMARY OF THE DISCLOSURE

The invention provides for creation of a simple, effective and rather accurate method to determine mudcake properties in a borehole, ensuring retrieving from a recorded signal all information on geometrical and filtration properties of the cake.

The method comprises registering by at least one acoustic sensor a pressure response to low frequency (LF) harmonic pressure oscillations generated in a borehole by at least one oscillation source. A phase shift of stationary pressure oscillations registered by the acoustic sensor relatively to the low frequency harmonic pressure oscillations of the oscillation source and a ratio between an amplitude of the stationary pressure oscillations registered by the acoustic sensor and an amplitude of the low frequency harmonic pressure oscillations of the oscillation source are determined from the registered signal. The cake thickness is determined. Based on data obtained a cake piezoconductivity or a fluid mobility or both are determined.

The oscillation source generating the LF harmonic pressure oscillations can be a natural source such as a LF noise generated during movement of tools in the borehole, a LF noise generated during drilling, a LF natural acoustic activity, a pump operation noise, a mud distant-sensing signal, etc.

The LF harmonic pressure oscillations can be excited by at least one artificial source. LF acoustic sensors/transducers, a LF modulation of the well pressure, etc., can be used as the artificial sources.

Hydrophones, transducers, vibration meters, accelerometers, pressure sensors etc. can be used as the acoustic sensors to register the pressure response.

The oscillation source generating the LF harmonic pressure oscillations can be simultaneously the acoustic sensor.

The oscillation source and/or the acoustic sensor can be installed on a packer.

The oscillation source and/or the acoustic sensor can be installed on a sampling probe.

The oscillation source and/or the acoustic sensor can be installed on a backup shoe.

Several oscillation sources installed at different places can be used.

The mudcake thickness is determined based on echo-pulse measurements including short high frequency (HF) signals supply to the formation and registration of the echo-signal time of arrival.

During the mudcake thickness determination it is preferable to supply the HF signals from at least two positions at different distances from the mudcake.

### DETAILED DESCRIPTION

The LF long-wave pressure oscillation in the borehole can be used as the oscillation source. They can be created by remote measurements of the mud pulses or by other means.

Advantages of the natural sources are that they are almost always present in a borehole environment, do not require introduction of additional components in a tool, do not require energy supply, etc. For example, a <<road noise>>, i.e., noise during movement of tools in the borehole, can have significant importance during the cable use, and generally is associated with an interaction between a tool and the borehole wall; drilling noise pertains to the measuring methods used during drilling and is produced by a drilling bit and a drill string interaction with rocks; a natural acoustic activity (for example, passive seismicity) can be useful in cases when the borehole environment is static (for example, wireline tools or BHA are stationary and do not move during measurements), etc. The natural sources in the form of a noise from a pump operation and a mud telemetry are of particular interest during the LF measurements. Almost always these two sources are present in the borehole (especially during drilling processes); they have the well known oscillation form (pumps and mud telemetry), the form can be controlled (mud telemetry); there is a possibility to generate rather low frequency oscillations (up to 1 Hz and below), and oscillations with rather long duration etc.

Advantages of the artificial sources are that they are available when necessary, do not depend significantly on external factors, generate repeating and reproducible signals that can be controlled and varied depending on needs, etc. For example, a LF sensor can permit reception of a controlled signal; a well pressure modulation is logic development of the natural source presented by the mud remote measurements, has its advantages and provides additional advantages in form of control flexibility, etc.

Advantages and disadvantages of various sensors working at low frequency are mainly similar to the advantages and disadvantages of the respective types of sources. For example, vibration meters ensure very accurate description of the surface oscillations; accelerometers can help to cover wide and especially a high frequency part of low frequency spectrum (1 Hz-tens kHz); standalone pressure sensors ensure measurements of a pressure signal and can be used even when the direct contact with mudcake/formation due to some reason is undesirable or impossible, or in such places as a probe inlet etc.

It is possible to use one or several oscillation sources, and one or several acoustic sensors. It should be mentioned that often one device can operate both as a source and as a sensor, ant these states can be either combined or switched. Further, there is a flexibility as to where these sources and/or sensors are placed. Examples include but not limited to:
a tool packer;
a pad of a sampling probe;
a backup shoe;
source(s)/receiver(s) mounted standalone;
etc.

Wide variety of options is important and provides numerous advantages. For example, placing source(s)/sensor(s) on the packer will ensure a good contact with the mudcake; placing them on a pad of the sampling probe will ensure the response measurement in vicinity of the probe inlet thus avoiding significant pressure signal attenuation (for example, if a sampling noise is used as the source), etc.; placing them on a backup shoe can compensate noise and ensures accurate measurement of the signal component associated with pressure diffusion through the mudcake; standalone mounting ensures flexibility during measurements and designing; etc.

Low frequency measurements can be significantly improved by use of several sensors. They can be installed in different places: a pad of a sampling probe, a backup shoe, etc. This can ensure the noise reduction or removal, as well as possibility of the differential pressure measurements. This can increase ratio <<signal-interference>>, reduce requirements for dynamic range and sensitivity, facilitate reduction of the possible effect of the measurement geometry etc.

For piezoconductivity, κ, measurements it is suggested to use an amplitude and a phase shift of induced oscillations registered by a LF acoustic sensor.

During measurements with an oscillating signal a pressure response at the sensor contains two components—a transient process reduced to zero with time, and temporary oscillations.

The cake piezoconductivity, κ, affects both processes, and for the quantitative estimation of κ value it is possible to use a phase shift, φ, of stationary pressure oscillations registered by an acoustic sensor relatively to pressure oscillations of an oscillation source, and ratio RA between an amplitude of the pressure oscillations registered by the sensor to an amplitude of an initial signal, i.e. low frequency harmonic pressure oscillations generated in a borehole by the oscillation source.

These pressure response characteristics are rigidly linked with κ. Their use is justified when the stationary pressure oscillations at the sensor are strong enough to make possible their extraction from the signal.

To extract the above mentioned quantitative values from the signal registered by the sensor we propose to use ideas of signal filtering and phase locked loops to separate the transient and oscillating processes. To determine phase and amplitude of the stationary oscillations the registered signal can be multiplied by harmonic signals with known phases and frequency of the source. After applying a LF filter and solving a simple system of linear equations it is possible to determine a phase shift (with 2 πn ambiguity), and an amplitude of the stationary oscillations. The algorithm can be implemented both in software (for separate processing of the pressure signal data), and in hardware (for example, for signal processing in well).

Due to the fact that actual parameters of formation and mudcake attenuation of pressure wave in the formation for frequencies above ˜1 Hz will be too high, it is recommended to implement this method using pressure signals at frequencies below ˜1 Hz. For such frequencies a characteristic scale of the pressure diffusion in the formation, λ*_{formation}, significantly exceeds a well radius, R_{b}. A characteristic scale of the pressure diffusion is related to piezoconductivity and signal frequency as λ*=2π\sqrt{2κ/ω}, where ω=2 πf. For frequency 1 Hz and actual parameters, λ* (typical length of diffusion wave), is within the range 10¹-10²m for formation and is below 10⁻²-10⁰m for the mudcake. Attenuation of an amplitude of the pressure oscillations during their propagation through the mudcake is characterized by ratio λ*_{mc} to a mudcake thickness h_{mc} (which is equal to exponent of this attenuation). Hence, it is recommended to maintain frequency at low level to minimize the pressure attenuation. For the actual parameters of the formation and the mudcake it is recommended to keep the sensor close to the source (˜10⁻²-10⁻¹ m), and signal frequency, f (˜10⁻³-1 Hz) shall be low. The lower frequency level is fₘ˜tₘ⁻¹, where tₘ is duration of measurements.

The piezoconductivity equation is solved upon setting of the semispace with flat border and thin layer on it (mudcake). Significant difference in time and spatial scales of the pressure diffusion in these two mediums (due to difference by several orders of their piezoconductivity coefficients) ensures the task division to two sub-tasks. First one—pressure diffusion in rock in the cylindrical coordinates. Second—one-dimensional pressure diffusion in the cake in direction at right angle to its surface. Upon all tasks' solutions gathering together we can receive a simple analytic solution in the series form. Extraction and analysis of its leading term ensure determination of the response amplitude and phase shift in relation to the initial signal.

The cake piezoconductivity, κ, is determined as follows

κ=2πfl/(2k*²)

So, for example, in case when the sampling probe is used as the oscillation source (see WO 2009/139992), k* is determined by equations solving

$$RA = \frac{rp}{ap} \sqrt{( 2 / ( cosh 2 {k}^{*} {h}_{mc} + cos 2 {k}^{*} {h}_{mc} ) )}$$

$$ϕ = {arg ( cosh {k}^{*} {h}_{mc} ( 1 + i ) )}^{- 1}$$

where RA is a ratio between an amplitude of stationary pressure oscillations registered by the sensor and an amplitude of the low frequency harmonic pressure oscillations of the oscillation sourse, h_{mc} is the mudcake thickness, rp is a radius of a sampling probe hole, ap is a distance from the sensor to a center of the sampling probe hole at which the pressure response is measured (ap>rp).

The mudcake thickness, h_{mc} , is preliminary determined based on the echo-pulse measurements including short HF signals supply to the formation and registration of the echo-signal time of arrival (see WO 2009/139992). During the mudcake thickness determination it is favourable to supply HF signals from at least two positions at different distances from the cake.

A fluid mobility, η, in the mudcake is determined as

η=κΦ/K

The cake porosity, Φ, is estimated as 10-30%, K is a volume Young's modulus of the porous medium.

1. A method for determining mudcake acoustic characteristics in a borehole, the method comprising:
registering by at least one acoustic sensor a pressure response to low frequency harmonic pressure oscillations generated in a borehole by at least one oscillation source,
determining from the registered signal a phase shift of stationary pressure oscillations registered by the acoustic sensor relative to the low frequency harmonic pressure oscillations of the oscillation source,
determining from the registered signal a ratio between an amplitude of the stationary pressure oscillations registered by the acoustic sensor and an amplitude of the low frequency harmonic pressure oscillations of the oscillation source,
determining a thickness of a mudcake; and
determining a cake piezoconductivity or a fluid mobility or both.

2. The method of claim 1, wherein the oscillation source generating the low frequency harmonic pressure oscillations is a natural source.

3. The method of claim 2, wherein the natural source of the low frequency harmonic oscillations is a low frequency noise generated during movement of tools in the borehole.

4. The method of claim 2, wherein the natural source of the low frequency harmonic oscillations is a low frequency noise generated during drilling.

5. The method of claim 2, wherein the natural source of the low frequency harmonic oscillations is a low frequency natural acoustic activity.

6. The method of claim 2, wherein the natural source of the low frequency harmonic oscillations is a borehole pump operation.

7. The method of claim 2, wherein the natural source of the low frequency harmonic oscillations is a mud remote measurement signal.

8. The method of claim 2, wherein at least one acoustic sensor is installed on a packer.

9. The method of claim 2, wherein at least one acoustic sensor is installed on a sampling probe.

10. The method of claim 2, wherein at least one acoustic sensor is installed on a backup shoe.

11. The method of claim 1, wherein the oscillation source generating the low frequency harmonic pressure oscillations is an artificial source.

12. The method of claim 11, wherein the source of the low frequency harmonic oscillations is simultaneously the acoustic sensor.

13. The method of claim 11, wherein the artificial source of the low frequency harmonic pressure oscillations is a low frequency borehole pressure modulation.

14. The method of claim 1, wherein vibration meters are used as the acoustic sensors to register the pressure response.

15. The method of claim 1, wherein hydrophones are used as the acoustic sensors to register the pressure response.

16. The method of claim 1, wherein transducers are used as the acoustic sensors to register the pressure response.

17. The method of claim 1, wherein accelerometers are used as the acoustic sensors to register the pressure response.

18. The method of claim 1, wherein pressure sensors are used as the acoustic sensors to register the pressure response.

19. The method of claim 11, wherein the oscillation source of the low frequency harmonic oscillations or the acoustic sensor or both are installed on a packer.

20. The method of claim 11, wherein the oscillation source of the low frequency harmonic oscillations or the acoustic sensor or both are installed on a sampling probe.

21. The method of claim 11, wherein the oscillation source of the low frequency harmonic oscillations or the acoustic sensor or both are installed on a backup shoe.

22. The method of claim 11, wherein several oscillation sources of the low frequency harmonic oscillations are installed at different places.

23. The method of claim 1, wherein the mudcake thickness is determined based on echo-pulse measurements comprising a short high frequency signals supply to the formation and registering echo-signals time of arrival.

24. The method of claim 23, wherein the short high frequency signals are supplied from at least two positions at different distances from the mudcake.
